(19) United States
(12) Patent Application Publication
(10) Pub. No.: US 2023/0014098 A1
(43) Pub. Date: Jan. 19, 2023

(54) METHOD AND SYSTEM FOR ACCELERATING READING OF INFORMATION OF FIELD REPLACE UNIT, DEVICE, AND MEDIUM

(71) Applicant: INSPUR SUZHOU INTELLIGENT TECHNOLOGY CO., LTD., Suzhou, Jiangsu (CN)

(72) Inventor: Shengnan LIANG, Suzhou, Jiangsu (CN)

(21) Appl. No.: 17/757,977

(22) PCT Filed: Aug. 26, 2020
(86) PCT No.: PCT/CN2020/111234

§ 371 Date: Jun. 24, 2022

(30) Foreign Application Priority Data
Dec. 26, 2019 (CN) 201911364252.1

(51) Int. Cl. G06F 12/02; G06F 13/16

(52) U.S. Cl. CPC G06F 12/0246; G06F 13/1668; G06F 2212/2022

(57) ABSTRACT

Disclosed are a method and system for accelerating reading of information of a Field Replace Unit (FRU), a device, and a storage medium. The method includes the following steps: creating, in a storage, a FRU virtual bus; constructing a node data structure based on information of each FRU, and mounting the node data structure to the FRU virtual bus; determining whether an instruction of reading information of a FRU is received; and in response to a receipt of the instruction of reading the information of the FRU, determining a position of the FRU on the FRU virtual bus, and reading the information of the FRU at the position.

This application claims priority to Chinese Patent Application No. 201911364252.1, filed on Dec. 26, 2019, in China National Intellectual Property Administration and entitled “Method and System for Accelerating Reading of Information of Field Replace Unit, Device, and Medium”, the contents of which are hereby incorporated by reference in its entirety.

### FIELD

The present disclosure relates to the field of port recognition, and more particularly to a method and system for accelerating reading of information of a Field Replace Unit (FRU), a computer device, and a readable medium.

### BACKGROUND

As a control chip capable of operating a Central Processing Unit (CPU) remotely on a main board of a white box switch as well as a set of system independent of the CPU of the switch, a Baseboard Management Controller (BMC) may remotely monitor some performance indexes of the switch system and execute a series of operations on the switch, such as a turning-on/off operation, system upgrading, and device checking. A BMC system is needed on a server or a white box switch to read device information of a FRU on the machine and check information about the hardware. Currently, a common method is to directly read data from an Electrically Erasable Programmable Read-Only Memory (EEPROM) of the FRU during each read/write, which is relatively slow. When a large amount of FRU information needs to be read, relatively long time is needed to display the information. When multiple pieces of software service need to use FRU information, data needs to be read from the EEPROM every time, which is relatively low in efficiency.

### SUMMARY

In view of this, an objective of embodiments of the present disclosure is to disclose a method and system for accelerating reading of information of a FRU, a computer device, and a computer-readable storage medium. A virtual bus is made persistent in a storage. As such, when FRU information needs to be displayed based on an Intelligent Platform Management Interface (IPMI) instruction or other software service needs to read the FRU information, it is only necessary to search for a corresponding device from the virtual bus in the storage, and the reading speed is higher than that of reading from EEPROM hardware practically by the service. Therefore, the speed of reading and writing information of a FRU may be increased greatly.

Based on the above objective, a first aspect of the embodiments of the present disclosure provides a method for accelerating reading of information of a FRU, including following steps: creating, in a storage, a FRU virtual bus; constructing a node data structure based on information of each FRU, and mounting the node data structure to the FRU virtual bus; determining whether an instruction of reading information of a FRU is received; and in response to a receipt of the instruction of reading information of the FRU, determining a position of the FRU on the FRU virtual bus, and reading the information of the FRU at the position.

In some embodiments, the step of constructing the node data structure based on information of each FRU includes: obtaining addresses of EEPROMs of all FRUs, reading each of the EEPROMs according to the addresses; converting binary information in the EEPROM into character string data, and constructing a corresponding node data structure based on the character string data.

In some embodiments, the method further includes: setting unique identification information in the node data structure, establishing a mapping relationship between a name of the FRU and the corresponding node data structure based on the unique identification information, and writing the mapping relationship to a mapping table.

In some embodiments, the method further includes: checking at a predetermined time interval whether the node data structure on the FRU virtual bus completely corresponds to the mapping table; and updating the mapping table in response to the node data structure on the FRU virtual bus not completely corresponding to the mapping table.

In some embodiments, the method further includes: encapsulating the FRU virtual bus and the node data structure into a dynamic link library.

Another aspect of the embodiments of the present disclosure also provides a system for accelerating reading of information of a FRU, including: a virtual bus module, configured to create, in a storage, a FRU virtual bus; a node data structure module, configured to construct a node data structure based on information of each FRU, and mount the node data structure to the FRU virtual bus; and an information reading module, configured to determine whether an instruction of reading information of a FRU is received, and in response to a receipt of the instruction of reading information of the FRU, determine a position of the FRU on the FRU virtual bus and read the information of the FRU at the position.

In some embodiments, the node data structure module is further configured to obtain addresses of EEPROMs of all FRUs, read each of the EEPROMs according to the addresses, convert binary information in the EEPROM into character string data, and construct a corresponding node data structure based on the character string data.

In some embodiments, the system further includes: a mapping module, configured to set unique identification information in the node data structure, establish a mapping relationship between a name of the FRU and the corresponding node data structure based on the unique identification information, and write the mapping relationship to a mapping table.

Another aspect of the embodiments of the present disclosure also provides a computer device, including: at least one processor; and a storage, storing a computer instruction capable of being performed in the processor, wherein the instruction is executed by the processor to implement the steps of the above method.

Another aspect of the embodiments of the present disclosure also provides a computer-readable storage medium, storing a computer program that is executed by a processor to implement the steps of the above method.

The present disclosure has the following beneficial technical effects. A virtual bus is made persistent in a storage. As such, when FRU information needs to be displayed based on an Intelligent Platform Management Interface (IPMI) instruction or other software service needs to read the FRU information, it is only necessary to search for a corresponding device from the FRU virtual bus in the storage, and the reading speed is higher than that of reading from EEPROM hardware practically by the service. Therefore, the speed of reading and writing information of a FRU may be increased greatly.

### BRIEF DESCRIPTION OF THE DRAWINGS

In order to describe the technical solutions in the embodiments of the present disclosure or the prior art more clearly, the drawings required to be used in descriptions about the embodiments or the prior art will be introduced briefly below. Apparently, the drawings in the description below are only some embodiments of the present disclosure. Those ordinarily skilled in the art may further obtain other embodiments according to these drawings without creative work.

FIG. 1 is a schematic diagram of an embodiment of a method for accelerating reading of information of a FRU according to the present disclosure; and

FIG. 2 is a schematic diagram of a hardware structure of an embodiment of a method for accelerating reading of information of a FRU according to the present disclosure.

### DETAILED DESCRIPTION

In order to make the objective, technical solutions, and advantages of the present disclosure clearer, the embodiments of the present disclosure will further be described below in detail in combination with specific embodiments and with reference to the drawings.

It is to be noted that all expressions made with “first”, “second”, etc., in the embodiments of the present disclosure are used for distinguishing two different entities or parameters with the same name, and thus it can be seen that “first” and “second” are only for ease of description and should not be understood as limitations on the embodiments of the present disclosure. No descriptions are made thereto in the following embodiments.

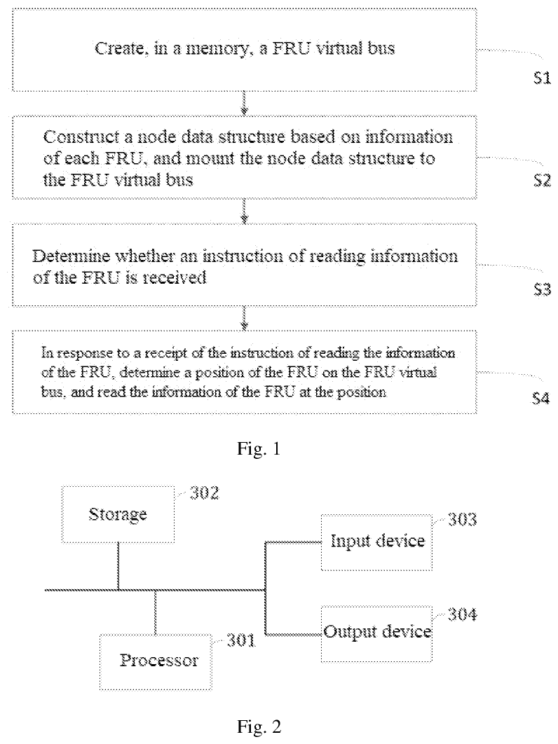

Based on the above objective, a first aspect of the embodiments of the present disclosure discloses an embodiment of a method for accelerating reading of information of a FRU. FIG. 1 is a schematic diagram of an embodiment of a method for accelerating reading of information of a FRU according to the present disclosure. As shown in FIG. 1, the embodiment of the present disclosure includes the following steps.

In S1, a FRU virtual bus is created in a storage.

In S2, a node data structure is constructed based on information of each FRU, and the node data structure is mounted to the FRU virtual bus.

In S3, whether an instruction of reading information of a FRU is received is determined.

In S4, in response to a receipt of the instruction of reading information of the FRU, a position of the FRU on the FRU virtual bus is determined, and the information of the FRU at the position is read.

After a BMC system is started, a FRU virtual bus management module daemon process (referred to fru-vbd hereinafter for short) is started first to create, in a storage, a FRU virtual bus structure. Then, EEPROMs of all FRUs are traversed, information in the EEPROMs is read, and software data structures are constructed according to a rule. An independent structure is formed for each FRU. Finally, each structure is mounted to the FRU virtual bus, thereby forming a complete bus data structure. Later on, when FRU information needs to be displayed based on an IPMI instruction or other software service needs to read the FRU information, it is only necessary to search for a corresponding device from the FRU virtual bus in the storage, and the reading speed is much higher than that of reading from EEPROM hardware practically by the service.

A FRU virtual bus is created in a storage. A fru-vbd process is designed. The FRU virtual bus created by the service is substantially a variable-length data structure stored in the storage. The fru-vbd process is responsible for maintenance, as well as addition, modification, or deletion of FRU node information on the bus.

A node data structure is constructed based on information of each FRU, and the node data structure is mounted to the FRU virtual bus. In some embodiments, the step that a node data structure is constructed based on information of each FRU includes that: addresses of EEPROMs of all FRUs are obtained, each of the EEPROMs is read according to the addresses, binary information in the EEPROM is converted into character string data, and a corresponding node data structure is constructed based on the character string data. The fru-vbd process obtains addresses of EEPROMs of all FRUs first from a configuration file, then traverses these addresses, sequentially reads the EEPROM of each FRU, translates binary information therein into human-readable character string data, and constructs a corresponding FRU node data structure based on the character string data. The constructed FRU node data structure is mounted to the FRU virtual bus, thereby forming a complete bus plus node data structure.

In some embodiments, the method further includes that: unique identification information is set in the node data structure, a mapping relationship between a name of the FRU and the corresponding node data structure is established based on the unique identification information, and the mapping relationship is written to a mapping table. The FRU node data structure may include the following information: unique identification information, i.e., a Universally Unique Identifier (UUID), a unique bus address, etc. A mapping relationship between a name of the FRU and the corresponding node data structure may be established, whereby unique identification information of the corresponding FRU node data structure may be obtained based on the name of the FRU for subsequent search.

Whether an instruction of reading information of a FRU is received is determined. In response to reception of the instruction of reading the information of the FRU, a position of the FRU on the FRU virtual bus is determined, and the information of the FRU at the position is read. The unique identification information of the corresponding FRU node data structure may be obtained based on the name of the FRU, thereby determining a position of the FRU on the FRU virtual bus and further reading the information of the corresponding FRU.

In some embodiments, the method further includes that: whether the node data structure on the FRU virtual bus completely corresponds to the mapping table is checked at a predetermined time interval; and the mapping table is updated in response to the node data structure on the FRU virtual bus not completely corresponding to the mapping table. In order to prevent the condition that a plugging/unplugging operation is performed on a certain FRU, it is necessary to check the practical node data structure on the FRU virtual bus, and if the node data structure FRU on the FRU virtual bus does not completely correspond to the mapping table, it indicates that the node data structure changes and the mapping table needs to be updated.

In some embodiments, the method further includes that: the FRU virtual bus and the node data structure are encapsulated into a dynamic link library. The FRU virtual bus and the node data structure are encapsulated into a dynamic link library libfruvbd.so for other software service to call conveniently, whereby query and data reading operations may be implemented on the FRU virtual bus.

It is to be particularly pointed out that the steps in each embodiment of the method for accelerating reading of information of a FRU may be mutually intersected, replaced, added, and deleted. Therefore, these reasonable permutations, combinations, and transformations about the method for accelerating reading of information of a FRU shall also fall within the scope of protection of the present disclosure, and the scope of protection of the present disclosure should not be limited to the embodiments.

Based on the above objective, a second aspect of the embodiments of the present disclosure discloses a system for accelerating reading of information of a FRU, including: a virtual bus module, configured to create, in a storage, a FRU virtual bus; a node data structure module, configured to construct a node data structure based on information of each FRU, and mount the node data structure to the FRU virtual bus; and an information reading module, configured to determine whether an instruction of reading information of a FRU is received, and in response to a receipt of the instruction of reading the information of the FRU, determine a position of the FRU on the FRU virtual bus and read the information of the FRU at the position.

The node data structure module is further configured to obtain addresses of EEPROMs of all FRUs, read each of the EEPROMs according to the addresses, convert binary information in the EEPROM into character string data, and construct a corresponding node data structure based on the character string data.

In some embodiments, the system further includes: a mapping module, configured to set unique identification information in the node data structure, establish a mapping relationship between a name of the FRU and the corresponding node data structure based on the unique identification information, and write the mapping relationship to a mapping table.

Based on the above objective, a third aspect of the embodiments of the present disclosure discloses a computer device, including: at least one processor; and a storage, storing a computer instruction capable of being performed in the processor. The instruction is executed by the processor to implement the following steps: S1: creating, in a storage, a FRU virtual bus; S2: constructing a node data structure based on information of each FRU, and mounting the node data structure to the FRU virtual bus; S3: determining whether an instruction of reading information of a FRU is received; and S4: in response to a receipt of the instruction of reading the information of the FRU, determining a position of the FRU on the FRU virtual bus, and reading the information of the FRU at the position.

In some embodiments, the step of constructing a node data structure based on information of each FRU includes: obtaining addresses of EEPROMs of all FRUs, reading each of the EEPROMs according to the addresses; converting binary information in the EEPROM into character string data, and constructing a corresponding node data structure based on the character string data.

In some embodiments, the following step is further included: setting unique identification information in the node data structure, establishing a mapping relationship between a name of the FRU and the corresponding node data structure based on the unique identification information, and writing the mapping relationship to a mapping table.

In some embodiments, the following steps are further included: checking at a predetermined time interval whether the node data structure on the FRU virtual bus completely corresponds to the mapping table; and updating the mapping table in response to the node data structure on the FRU virtual bus not completely corresponding to the mapping table.

In some embodiments, the following step is further included: encapsulating the FRU virtual bus and the node data structure into a dynamic link library.

FIG. 2 is a schematic diagram of a hardware structure of an embodiment of a method for accelerating reading of information of a FRU according to the present disclosure.

Taking the apparatus shown in FIG. 2 as an example, the apparatus includes a processor 301 and a storage 302, and may further include an input device 303 and an output device 304.

The processor 301, the storage 302, the input device 303, and the output device 304 may be connected by a bus or other manners. FIG. 2 takes connection by a bus as an example.

As a nonvolatile computer-readable storage medium, the storage 302 may be used to store a nonvolatile software program, a nonvolatile computer-executable program, and a module, such as a program instruction/module corresponding to the method for accelerating reading of information of a FRU in the embodiments of the present application. The processor 301 performs the nonvolatile software program, instruction, and module stored in the storage 302, thereby executing various types of function applications and data processing of a server, namely implementing the method for accelerating reading of information of a FRU in the method embodiment.

The storage 302 may include a program storage region and a data storage region. The program storage region may store an operating system and an application program needed by at least one function. The data storage region may store data created according to the use of the method for accelerating reading of information of a FRU, etc. In addition, the storage 302 may include a high-speed Random Access Memory (RAM), and may also include a nonvolatile storage, such as at least one disc storage device, flash storage device, or another volatile solid-state storage device. In some embodiments, the storage 302 optionally includes a storage arranged remotely relative to the processor 301, and the remote storage may be connected to a local module through a network. Examples of the network include, but not limited to, the Internet, an intranet, a local area network, a mobile communication network, and a combination thereof.

The input device 303 may receive input information such as a username and a password. The output device 304 may include a display device such as a display screen.

One or more program instructions/modules corresponding to the method for accelerating reading of information of a FRU are stored in the storage 302 and executed by the processor 301 to execute the method for accelerating reading of information of a FRU in any method embodiment.

Any embodiment of the computer device executing the method for accelerating reading of information of a FRU may have effects the same as or similar to those of any corresponding method embodiment.

The present disclosure also provides a computer-readable storage medium, storing a computer program that is executed by a processor to execute the above method.

It is finally to be noted that those ordinarily skilled in the art can understand that all or part of flows in the method of the above-mentioned embodiment may be completed by a computer program by instructing related hardware. The program for the method for accelerating reading of information of a FRU may be stored in a computer-readable storage medium. When the program is executed, the flows of each method embodiment may be included. The storage medium storing the program may be a magnetic disk, an optical disk, a Read-Only Memory (ROM), RAM, etc. The embodiment of the computer program may have effects the same as or similar to those in any corresponding method embodiment.

In addition, the method disclosed according to the embodiments of the present disclosure may also be implemented as a computer program executed by a processor. The computer program may be stored in a computer-readable storage medium. When the computer program is executed by the processor, the functions defined in the method disclosed in the embodiments of the present disclosure are executed.

Moreover, each method step and system unit may also be implemented by a controller and a computer-readable storage medium configured to store a computer program enabling the controller to implement the steps or functions of the units.

Furthermore, it is to be understood that the computer-readable storage medium (such as a storage) herein may be a volatile storage or a nonvolatile storage, or may include both a volatile storage and a nonvolatile storage. As an example rather than a restriction, the nonvolatile storage may include a ROM, a Programmable ROM (PROM), an Electrically PROM (EPROM), an EEPROM, or a flash storage. The volatile storage may include a RAM which may be used as an external cache storage. As an example rather than a restriction, the RAM may be obtained in various forms, such as a Synchronous RAM (SRAM), a Dynamic RAM (DRAM), a Synchronous DRAM (SDRAM), a Double Data Rate (DDR) SDRAM, an Enhanced SDRAM (ESDRAM), a Synchronous Link DRAM (SLDRAM), and a Direct Rambus RAM (DRRAM). The storage device in the disclosed aspect is intended to include, but not limited to, these or other proper types of memories.

It is also understood by those skilled in the art that various exemplary logic blocks, modules, circuits, and algorithm steps described in combination with the disclosure herein may be implemented as electronic hardware, computer software, or a combination thereof. For ease of description about such interchangeability of hardware and software, functions of various schematic components, blocks, modules, circuits, and steps are described generally. Whether these functions are implemented as software or hardware depends on specific applications and design constraints on the whole system. Those skilled in the art may realize the functions for each specific application in various manners, but such realization should not be explained as resulting in departure from the scope disclosed in the embodiment of the present disclosure.

Various exemplary logic blocks, modules, and circuits described in combination with the disclosure herein may be implemented or executed by the following components designed to execute the functions herein: a general-purpose processor, a Digital Signal Processor (DSP), an Application Specific Integrated Circuit (ASIC), a Field-Programmable Gate Array (FPGA) or another programmable logic device, a discrete gate or transistor logic, a discrete hardware component, or any combination thereof. The general-purpose processor may be a microprocessor. However, the processor may alternatively be any conventional processor, controller, microcontroller, or state machine. The processor may also be implemented as a combination of computing devices, such as a combination of a DSP and a microprocessor, multiple microprocessors, a combination of one or more microprocessors and a DSP, and/or any other such configuration.

The steps of the method or algorithm described in combination with the disclosure herein may be directly included in hardware, a software module executed by the processor, or a combination thereof. The software module may be located in a RAM, a flash storage, a ROM, an EPROM, an EEPROM, a register, a hard disk, a removable disk, a Compact Disc ROM (CD-ROM), or a storage medium of any other form well known in this art. The storage medium is exemplarily coupled to the processor such that the processor may read information from the storage medium or write information to the storage medium. In an alternative solution, the storage medium may be integrated with the processor. The processor and the storage medium may be located in an ASIC. The ASIC may be located in a user terminal. In an alternative solution, the processor and the storage medium may be located in a user terminal as discrete components.

In one or more exemplary designs, the function may be realized in hardware, software, firmware, or any combination thereof. If being realized in software, the function may be stored in a computer-readable medium or transmitted through the computer-readable medium as one or more instructions or codes. The computer-readable medium includes a computer storage medium and a communication medium. The communication medium includes any medium that helps to transmit a computer program from one position to another. The storage medium may be any available medium accessible for a general-purpose or special-purpose computer. As an example rather than a restriction, the computer-readable medium may include a RAM, a ROM, an EEPROM, a CD-ROM or another optical disc storage device, a disk storage device or another magnetic storage device, or any other medium available for carrying or storing a needed program code in form of an instruction or a data structure and accessible for a general-purpose or special-purpose computer or a general-purpose or special-purpose processor. In addition, any connection may be referred to as a computer-readable medium as appropriate. For example, if a coaxial cable, a fiber optic cable, a twisted pair, a Digital Subscriber Line (DSL), or a wireless technology like infrared, radio, and microwave is used to send software from a website, a server, or another remote source, the coaxial cable, the fiber optic cable, the twisted pair, the DSL, or the wireless technology like infrared, radio, and microwave is included in the definition of the medium. As used herein, the magnetic disk and the optical disc include a Compact Disc (CD), a laser disc, an optical disc, a Digital Versatile Disc (DVD), a floppy disc, and a blue-ray disc. Generally, the magnetic disk magnetically reproduces data, while the optical disc optically reproduces data using laser. Combinations of the above-mentioned contents should also be included in the scope of the computer-readable medium.

The above is the exemplary embodiment disclosed in the present disclosure. However, it is to be noted that various variations and modifications may be made without departing from the scope defined in the claims and disclosed in the embodiments of the present disclosure. The functions, steps, and/or actions in the method claims according to the disclosed embodiments described herein are not required to be executed in any specific sequence. In addition, the element disclosed in the embodiments of the present disclosure may be described or required in an individual form, but may be understood as a plural form, unless clearly limited to a singular form.

It is to be understood that, as used herein, the singular form “a/an” is intended to include the plural form also, unless exceptional cases are supported clearly in the context. It is also to be understood that “and/or” used herein refers to including any or all possible combinations of one or more than one item that is listed associatively.

The sequence numbers of the embodiments of the present disclosure are only for description and do not represent superiority-inferiority of the embodiments.

It can be understood by those ordinarily skilled in the art that all or part of the steps of the above-mentioned embodiments may be completed by hardware, or by a program by instructing related hardware. The program may be stored in a computer-readable storage medium. The above-mentioned storage medium may be a ROM, a magnetic disk, an optical disk, or the like.

It is to be understood by those ordinarily skilled in the art that discussions about any above embodiment are only exemplary and not intended to imply that the scope (including the claims) disclosed in the embodiments of the present disclosure is limited to these examples. Under the concept of the embodiments of the present disclosure, the above embodiments or technical features in different embodiments may also be combined, and there are many other variations of different aspects of the embodiments of the present disclosure, which are not provided in details for brevity. Therefore, any omissions, modifications, equivalent replacements, improvements, etc., made within the spirit and principle of the embodiments of the present disclosure shall fall within the scope of protection of the embodiments of the present disclosure.

1. A method for accelerating reading of information of a Field Replace Unit (FRU), comprising following steps:
creating, in a storage, a FRU virtual bus;
constructing a node data structure based on information of each FRU, and mounting the node data structure to the FRU virtual bus;
determining whether an instruction of reading information of the FRU is received; and
in response to a receipt of the instruction of reading the information of the FRU, determining a position of the FRU on the FRU virtual bus, and reading the information of the FRU at the position.

2. The method according to claim 1, wherein the step of constructing the node data structure based on information of each FRU comprises:
obtaining addresses of Electrically Erasable Programmable Read-Only Memories (EEPROMs) of all FRUs, reading each of the EEPROMs according to the addresses;
converting binary information in the EEPROMs into character string data; and
constructing a corresponding node data structure based on the character string data.

3. The method according to claim 1, further comprising:
setting unique identification information in the node data structure, establishing a mapping relationship between a name of the FRU and the corresponding node data structure based on the unique identification information, and writing the mapping relationship to a mapping table.

4. The method according to claim 3, further comprising:
checking at a predetermined time interval whether the node data structure on the FRU virtual bus completely corresponds to the mapping table; and
updating the mapping table in response to the node data structure on the FRU virtual bus not completely corresponding to the mapping table.

5. The method according to claim 1, further comprising:
encapsulating the FRU virtual bus and the node data structure into a dynamic link library.

6.-8. (canceled)

9. A computer device, comprising:
at least one processor; and
a storage, storing a computer instruction configured to be performed in the at least one processor, wherein the computer instruction is executed by the at least one processor to implement steps of:
creating, in a storage, a Field Replace Unit (FRU) virtual bus;
constructing a node data structure based on information of each FRU, and mounting the node data structure to the FRU virtual bus;
determining whether an instruction of reading information of a FRU is received; and
in response to a receipt of the instruction of reading the information of the FRU, determining a position of the FRU on the FRU virtual bus, and reading the information of the FRU at the position.

10. A computer-readable storage medium, storing a computer program, wherein the computer program is executed by a processor to implement steps of:
creating, in a storage, a Field Replace Unit (FRU) virtual bus;
constructing a node data structure based on information of each FRU, and mounting the node data structure to the FRU virtual bus;
determining whether an instruction of reading information of a FRU is received; and
in response to a receipt of the instruction of reading the information of the FRU, determining a position of the FRU on the FRU virtual bus, and reading the information of the FRU at the position.

11. The method according to claim 1, wherein After a Baseboard Management Controller (BMC) system is started, a FRU virtual bus management module daemon (fru-vbd) process is started first to create, in the storage, a FRU virtual bus structure; EEPROMs of all FRUs are traversed, information in the EEPROMs is read, and software data structures are constructed according to a rule; an independent structure is formed for each FRU; each structure is mounted to the FRU virtual bus, thereby forming a complete bus data structure.

12. The method according to claim 11, wherein the fru-vbd process is designed, the fru-vbd process is responsible for maintenance, as well as addition, modification, or deletion of FRU node information on the FRU virtual bus.

13. The method according to claim 11, wherein the fru-vbd process obtains addresses of EEPROMs of all FRUs first from a configuration file, traverses these addresses, sequentially reads the EEPROM of each FRU, translates binary information therein into human-readable character string data, and constructs a corresponding FRU node data structure based on the character string data.

14. The method according to claim 13, wherein the mapping relationship between a name of the FRU and the corresponding node data structure is established, whereby unique identification information of the corresponding FRU node data structure is obtained based on the name of the FRU for subsequent search.

15. The method according to claim 5, wherein the FRU virtual bus and the node data structure are encapsulated into a dynamic link library libfruvbd.so for other software service to call conveniently, whereby query and data reading operations are implemented on the FRU virtual bus.

16. The computer device according to claim 9, wherein the step of constructing the node data structure based on information of each FRU comprises:
obtaining addresses of Electrically Erasable Programmable Read-Only Memories (EEPROMs) of all FRUs, reading each of the EEPROMs according to the addresses;
converting binary information in the EEPROMs into character string data; and
constructing a corresponding node data structure based on the character string data.

17. The computer device according to claim 9, further comprising steps of:
setting unique identification information in the node data structure, establishing a mapping relationship between a name of the FRU and the corresponding node data structure based on the unique identification information, and writing the mapping relationship to a mapping table.

18. The computer device according to claim 17, further comprising steps of:
checking at a predetermined time interval whether the node data structure on the FRU virtual bus completely corresponds to the mapping table; and
updating the mapping table in response to the node data structure on the FRU virtual bus not completely corresponding to the mapping table.

19. The computer device according to claim 9, further comprising a step of:
encapsulating the FRU virtual bus and the node data structure into a dynamic link library.

20. The computer-readable storage medium according to claim 10, wherein the step of constructing the node data structure based on information of each FRU comprises:
obtaining addresses of Electrically Erasable Programmable Read-Only Memories (EEPROMs) of all FRUs, reading each of the EEPROMs according to the addresses;
converting binary information in the EEPROMs into character string data; and
constructing a corresponding node data structure based on the character string data.

21. The computer-readable storage medium according to claim 10, further comprising steps of:
setting unique identification information in the node data structure, establishing a mapping relationship between a name of the FRU and the corresponding node data structure based on the unique identification information, and writing the mapping relationship to a mapping table.

22. The computer-readable storage medium according to claim 21, further comprising steps of:
checking at a predetermined time interval whether the node data structure on the FRU virtual bus completely corresponds to the mapping table; and
updating the mapping table in response to the node data structure on the FRU virtual bus not completely corresponding to the mapping table.

23. The computer-readable storage medium according to claim 10, further comprising a step of:
encapsulating the FRU virtual bus and the node data structure into a dynamic link library.
